(19) United States
(12) Patent Application Publication
(10) Pub. No.: US 2017/0047832 A1
(43) Pub. Date: Feb. 16, 2017

(54) Electric Motor and Process for Making an Electric Motor

(71) Applicant: Caterpillar Inc., Peoria, IL (US)

(72) Inventor: Myrna Dominguez Juarez, Nuevo Laredo (MX)

(73) Assignee: Caterpillar Inc., Peoria, IL (US)

(21) Appl. No.: 14/825,900

(22) Filed: Aug. 13, 2015

(51) Int. Cl. H02K 15/12; H02K 15/00; H02K 3/32

(52) U.S. Cl. CPC H02K 15/12; H02K 3/32; H02K 15/0006

(57) ABSTRACT

An electric motor includes a stationary stator and a rotating rotor. To assemble the rotor, a grease is applied to at least a portion of the shaft of the rotor proximate a rotor core disposed on the shaft. A liquid varnish is applied to the rotor core and allowed to harden. The grease can be removed from the shaft along with any varnish that had hardened thereon. Later, the same grease can be reapplied to the shaft to facilitate installation of a bearing onto the shaft. The process can apply to the assembly of new electric motors or to the remanufacturing of previously constructed motors.

### TECHNICAL FIELD

This patent disclosure relates generally to electric motors and, more particularly, to a process for manufacturing or reassembling the internal components of an electric motor.

### BACKGROUND

An electric motor is an electromagnetic device that converts electricity into a mechanical force in the form of motion that can be used for performing mechanical work in any number of diverse applications. Electric motors are available in a variety of sizes, shapes, power ratings, configurations, and may operate on direct current (“DC”) or alternating current (“AC”) electricity depending upon their configuration. For example, a typical motor may be designed to provide a rotational motion and torque on a rod-like shaft extending from the motor that can be mechanically coupled to other devices or components for the transmission of power. To rotate the shaft, the shaft can be formed as part of a rotor that is disposed inside of and rotatably supported within a stationary stator. When electricity is supplied to the electric motor, a magnetic field is created between the rotor and the stator that forces the rotor to rotate or spin within the stator, thereby exerting torque to the shaft causing rotation. In some instances, especially when the motor utilizes DC electricity, the rotor may also be referred to as an armature.

To generate the magnetic field utilizing the applied electricity, the rotor and/or stator may be constructed of various windings, coils, laminations, conductive plates, and the like that are arranged to electromagnetically interact according to known technologies. Often varnish is applied to some of these components during manufacture of the electric motor for insulation purposes and to integrally hold the components together. U.S. Pat. No. 2,831,991 (“the '991 patent”) describes one method of applying varnish to at least the rotor portion of an electric motor. The method involves assembling a rotor core that may include a plurality of conductive wire windings wound around a shaft and that are arranged with a commuter to receive and conduct electrical current, thereby forming an armature portion of the intended DC motor. The assembly is placed into a cavity of an open mold and resin is introduced to the mold to fill the cavity and allowed to penetrate through and around the windings of the rotor core. The resin may be cured into a varnish coating during a heating process and the mold is disassembled after cooling to release the assembled rotor. While the open mold process described in the '991 patent has been a common manufacturing technique for assembling rotors and armatures over the years, the present disclosure is directed to improving upon this process.

### SUMMARY

The disclosure describes, in one aspect, a method for manufacturing a rotor for use in an electric motor. According to the method, a partly assembled rotor is provided that includes a shaft defining a shaft axis and a rotor core disposed around the shaft. The rotor core is positioned on the shaft so that the exposed shaft length protrudes from a forward face of the rotor. Grease can be applied radially about at least a portion of the exposed shaft length proximate the forward face of the rotor core. The partly assembled rotor is placed in a mold and varnish is applied to the rotor core which is allowed to harden. The partly assembled rotor can be removed from the mold and the grease and any varnish deposited on the exposed shaft length can be removed from the exposed shaft length.

In another aspect of the disclosure, there is described an assembly line for the assembly of electric motors. The assembly line includes a first grease application station with a first supply of grease that is adapted to apply the grease to at least a portion of an exposed shaft length protruding from a rotor core of a partly assembled rotor. The assembly line also includes a mold fitting station having a plurality of molds adapted to receive and support the partly assembled rotor. A varnish application station is supplied with varnish and can be used to apply the varnish to the rotor core of the partly assembled rotor in the mold. Once the varnish is applied, the assembly line can include an enclosed furnace having an access that can receive the partly assembled rotor in the mold and generate heat to facilitate hardening of the varnish. Subsequent to the furnace, a cleanup station is included for removing the grease and any of the varnish deposited thereon from the exposed shaft length. The assembly line also includes a second grease application station having a second supply of grease for reapplying the grease to the exposed shaft length.

According to yet another aspect, the disclosure describes a method of recycling a rotor for an electric motor by recovering a partly assembled rotor from an electric motor that had been previously constructed. The partly assembled rotor includes a shaft with an elongated rod-like shape extending between a first end and a second end and a rotor core disposed partially about the shaft and radially extending from the shaft. The rotor core can have a forward face terminating behind the first end of the shaft so that an exposed shaft length protrudes from the forward face. Further according to the method, grease is applied radially about at least a portion of the exposed shaft length proximate the forward face of the rotor core. The partly assembled rotor is supported in a mold and varnish is applied to the rotor core of the partly assembled rotor in the mold and allowed to harden. The grease is removed from the exposed shaft length along with any of the varnish deposited thereon with a low impact force. The method also provides for reapplication of the grease radially about at least a portion of the exposed shaft length proximate the forward face of the rotor core to aid in installation of a bearing on the exposed shaft length with aid of the reapplied grease.

In another aspect of the disclosure, there is described an electric motor with a rotor having a shaft with an elongated rod-like shape extending from a first end to a second end that defines a shaft axis. The rotor also includes a rotor core disposed partially about the shaft and extending radially from the shaft. The rotor core has a forward face and is disposed on the shaft so that an exposed shaft length extends from the forward face. A varnish coating is coated on the rotor but is substantially absent from the exposed shaft length due to application of a grease to the exposed shaft length prior to application of the varnish coating and subsequent removal of the grease. A bearing is disposed on the exposed shaft length over the grease as reapplied to exposed shaft length.

### BRIEF DESCRIPTION OF THE DRAWINGS

FIG. 1 is a schematic cross-sectional view illustrating the various components of an electrical motor including a rotor supported by one or more bearings as assembled in accordance with the present disclosure.

FIG. 2 is a schematic representation of an assembly line for assembling an electric motor from scratch or recovering a previously constructed motor which includes a varnish application process in accordance with the present disclosure.

FIG. 3 is a front perspective view of grease being applied to the shaft of an electric motor prior to the varnish application process of FIG. 2.

### DETAILED DESCRIPTION

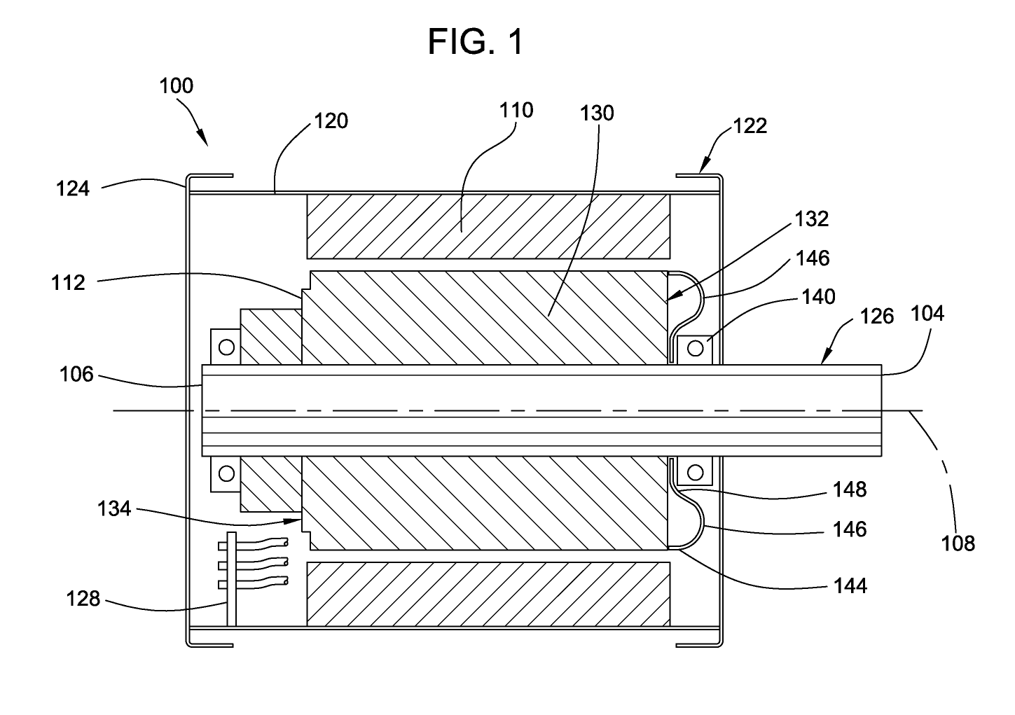

This disclosure relates to electric motors and to processes for improving the assembly or construction of electric motors, either initially or during the recycling or remanufacturing of electrical motors. Now referring to FIG. 1, wherein like reference numbers refer to like elements, there is illustrated a schematic representation of an electric motor 100 that may be assembled in accordance with the disclosure. The electric motor 100 can have any suitable electrical configuration such as a direct current (DC) motor, an alternating current (AC) inductance motor, an AC synchronous motor, a stepper motor, and the like. Additionally, the motor can be of any suitable size and output capacity; however, in the preferred embodiment the motor may be intended for use as an engine starter motor and can be assembled largely by hand without the need for cranes, lifts and the like. In various embodiments, the electric motor may be intended in for use as a starter motor for diesel compression ignition engines or for ancillary applications used in conjunction with mobile or stationary machinery that utilize such engines.

The electric motor 100 produces torque by rotating a shaft 102 that may have a rod-like shape extending between a first end 104 and a second end 106, thereby defining a shaft axis 108 corresponding to an axis of rotation with respect to the motor. The shaft 102 accordingly functions as the mechanical output of the electric motor 100 and will connect with, directly or indirectly, the equipment operatively associated with and powered by the motor. To rotate the shaft 102, the electric motor 100 utilizes an electromagnetic field or fields generated between and interacting with a stationary stator 110 that is disposed about a rotatable rotor 112 that includes the shaft. To house the stator 110, the rotor 112, and other interacting electromagnetic components, and to inhibit their contamination from dirt and debris, the electric motor 100 can include a housing 120 that can be generally formed as a hollow, tubular, canister made from, for example, formed sheet metal or a casting, and into which the other components can be inserted. The housing 120 can be enclosed at its opposing ends by a first end cap 122 and a second end cap 124. The shaft 102 of the electric motor 100 may have an exposed shaft length 126 corresponding to the first end 104 that protrudes from the first end cap 122 to mechanically couple with the associated machinery and equipment. In some embodiments, the distal first end 104 may include a spline to facilitate coupling.

To receive electrical power from a power supply, the electric motor 100 can include an appropriate wiring configuration 128 that may be accessible through the second end cap 124. The wiring configuration 128 may be designed to receive DC electricity, single-phase AC electricity, three-phase AC electricity, or any other suitable variations of electrical power. The wiring configuration 128 may include a terminal board or terminals that can electrically connect with the power source and distribute power to the appropriate internal components for operation of the electric motor. Additional components that may be included in the housing 120 may include capacitors, solenoids, power transformers, shunts, grounds, and the like to facilitate operation of the electric motor 100.

The actual construction of the stator 110 and rotor 112 can depend upon the type of electricity received by the electric motor 100. In particular, the rotor 112 can include multiple different components disposed radially about the shaft 102 that produce the rotor's electromagnetic properties. These components may include windings, coils, structural components, magnetic components, and the like that extend radially outward from the shaft 102 and that may be referred to as the rotor core 130. The rotor core 130 may be shorter than the shaft 102 and delineates a forward face 132 and a rearward face 134 that are axially positioned so that the first end 104 and the second end 106 of the shaft are spaced beyond the rotor core. In the illustrated embodiment, the rotor core 130 may terminate with respect to the shaft 102 with its forward face 132 positioned substantially rearward such that the first end 104 of the shaft projects a substantial distance to provide the exposed shaft length 126.

If intended for DC operation, the construction of the rotor core 130 may include a plurality of conductive wires looped or coiled lengthwise with respect to the shaft 102 that may be parallel to or slightly rotated helically with respect to the shaft axis 108. Additional structures may be included to support the windings and facilitate their electromagnetic characteristics. The conductive windings in the rotor core 130 may communicate electrically with power supplied to the wiring configuration 128 via a commuter and brushes to periodically switch the direction of current flowing in the windings. The stator 110 may be formed as a plurality of additional windings coiled around magnetizable materials arranged generally parallel to the shaft axis 108 that are also connected to a power source via the wiring configuration 128. The windings on the stator 110 and the rotor core 130 function as electromagnetic poles when energized. Hence, when electrical power is applied, the magnetic fields generated by the stator 110 can attract and repel the corresponding fields generated by the current flowing in the windings of the rotor core 130 to rotate and create torque in the shaft 102.

In another example, if intending to utilize AC power, the rotor core 130 may be constructed as a plurality of magnetizable elements assembled together by a metal cage of conductive material sometimes referred to as a squirrel cage. In an embodiment, the magnetizable elements may be formed by a plurality of laminations including ferrous materials that are stacked adjacently to each other and aligned axially along the shaft 102. When AC power is applied to the windings in the stator 110 surrounding the rotor 112, the alternating current generates cyclic magnetic fields that rotate around the stator windings disposed radially about the shaft axis 108 in synchronization with the frequency of the power source. The magnetic fields induce current in the conductive portions of the rotor core 130 that results in the generation of secondary magnetic fields. The secondary magnetic fields interact with the primary fields from the stator 110 to cause the rotor 112 to rotate. In other embodiment, the construction of the internal components, including the stator and rotor core and their electromagnetic interactions, may be in accordance with other well-known constructions. As will be explained further herein, regardless of whether the rotor is intended for DC or AC operation, a varnish or lacquer coating may be applied to the rotor core 130 to electrically insulate the components of the rotor core from the other components inside the housing and possibly to assist holding the rotor core integrally together.

To physically enable the rotor 112 to rotate within the stationary stator 110, the rotor can be supported by a first bearing 140 and a second bearing 142 disposed proximate to the forward face 132 and the rearward face 134 of the rotor core 130 respectively and inside of the first end cap 122 and second end cap 124. The bearings 140, 142 can installed on the shaft 102 by an interference fit and can be pressed adjacent to the forward or rearward faces 132, 134, respectively, of the rotor core 130. The first and second bearings 140, 142 can be responsible for aligning and fixing rotation of the rotor 112, which corresponds to the shaft axis 108, with respect to the stator 110 and the housing 120 of the electric motor 100. While the schematic indicates the bearings 140, 142 are ball bearings, in other embodiments, the bearings can be any suitable type of bearing including roller bearings, journal bearings, bushings, and the like which enables relative rotational rotation of the rotor 112 with respect to the stator 110.

Because the electromagnetic interactions between the components generates heat, the electric motor may include one or more fan plates 144 disposed inside the housing 120 to promote air flow over the components and cool the interior of the motor. In the illustrated embodiment, the fan plate 144 can be fixed to the shaft 102 and disposed toward the front of the rotor core 130 to spin with the rotor 112. The fan plate 144 can include a plurality of raised blades 146 or fins extending radially outward from a central recessed portion 148. The raised blades 146 may also be axially displaced with respect to the central recessed potion 148 so that the recessed portion is shaped to accommodate the first bearing 140 with the blades protruding around it. The plurality of raised blades 146 may also be radially separated or spaced apart from each other by slots or gaps. When the rotor core 130 rotates, the plurality of raised blades 146 create airflow through the housing 120 and between the stator 110 and rotor 112. In an embodiment, the fan plate may be cast from aluminum or may be formed by a stamping and forming operation.

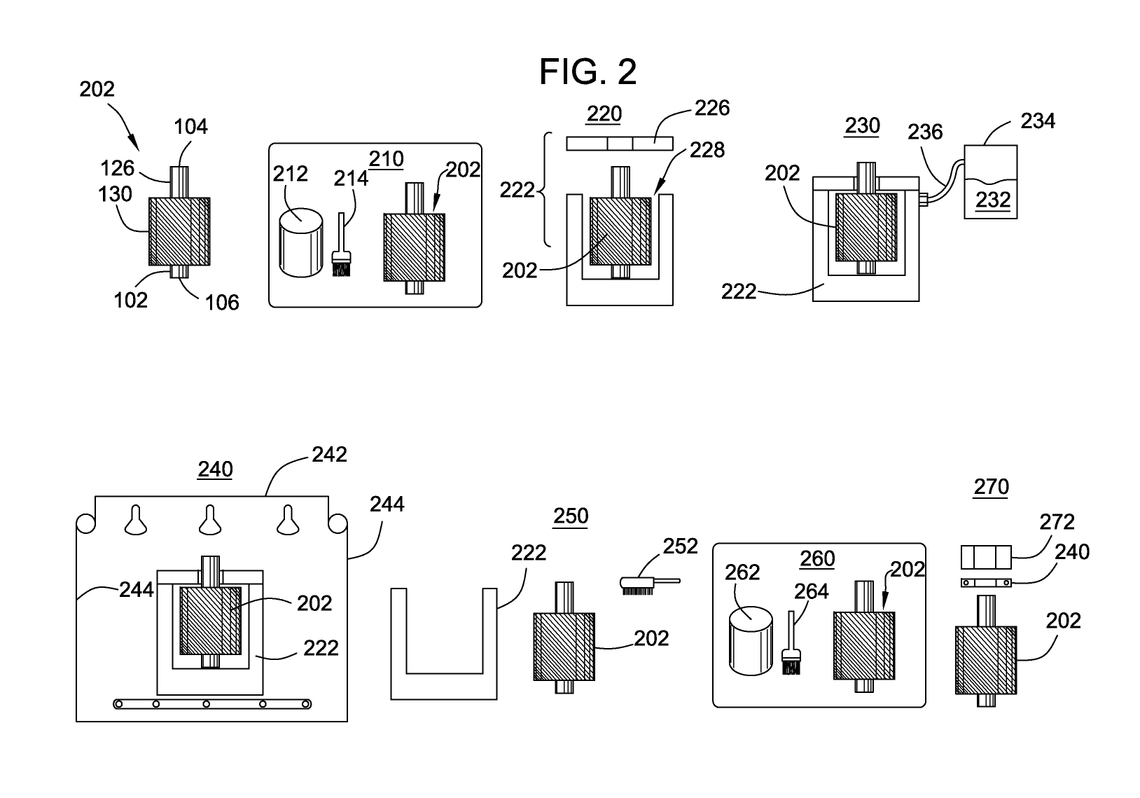

Referring to FIG. 2, there is illustrated a schematic representation of an assembly line 200, or more particularly to a portion of an assembly line, for producing electric motors 100 of any of the foregoing types. The particular portion of the assembly line concerns a varnish application process for applying varnish to the rotor of an electric motor but may be part of a larger assembly process for the production of a complete electric motor. It should be appreciated that the assembly line 200 may be for the production of new motors from raw components or may be intended for the repair of a previously manufactured motor. It should be further recognized that the term “assembly line” is used according to its broadest meaning in accordance with the manufacturing arts to refer to a series of stations or assembly steps that may take place in any order and in any number of physical arrangements or layouts. The term “assembly line” and the following description of particular processes should therefore not be construed to limit the disclosure to a particular physical layout or to the particular details of an embodiment of a specific assembly step.

The assembly line processes represented by FIG. 2 may start with a supply of partly assembled rotors 202 that include the shaft 102 and the rotor core 130 partially disposed about the shaft and positioned between the first end 104 and the second end 106 to provide the exposed shaft length 126. The rotor core 130 may be of any of the foregoing types of construction and may include windings, magnetic structural components, laminations, and the like. As indicated, the partly assembled rotors 202 can be supplied from an earlier initial assembly portion of the assembly line in which the partly assembled rotors were assembled from raw components to produce a new electric motor. The partly assembled rotors 202 may also be supplied from earlier recovery steps in which the rotors were removed from a previously constructed electric motor that is being repaired. In such an embodiment, the partly assembled rotor 202 may have undergone cleaning and other repair steps prior to reaching the portion of the assembly line 200 depicted in FIG. 2.

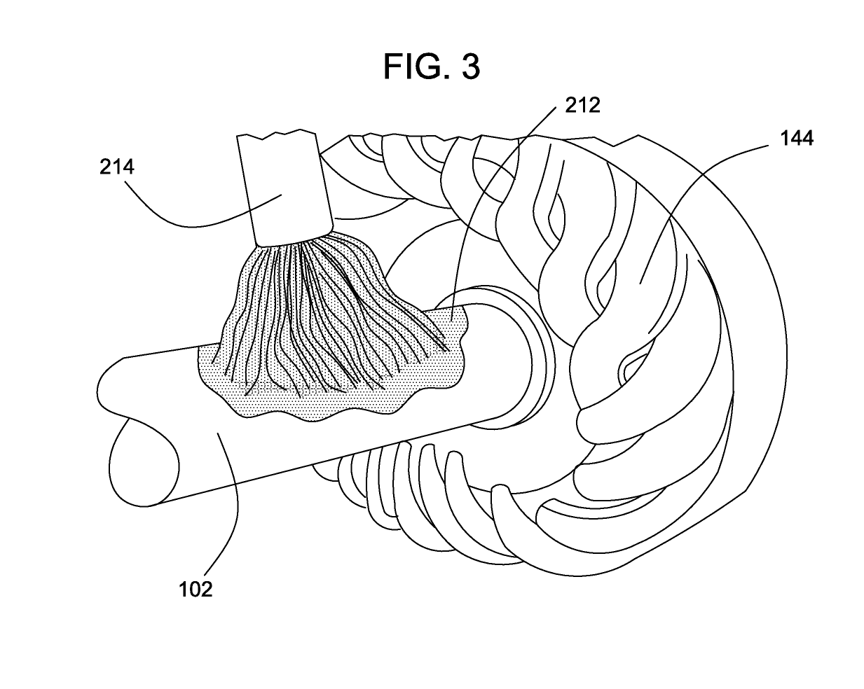

In accordance with the disclosed assembly process, the assembly line 200 includes a first grease application station 210 to apply grease to the shaft 102 of the partly assembled rotor 202 to facilitate other steps of the assembly process. In particular, referring to FIGS. 2 and 3, grease is applied to at least the exposed shaft length 126 of the shaft 102 adjacent to where the shaft protrudes through the fan plate 144 and may be applied to the other portions of the shaft that are exposed with respect to the rotor core 130 such as the second end 106. To apply the grease, which may be accomplished by hand, the first grease application station 210 includes a first supply of grease 212 and a brush 214 having bristles that can retain the grease until placed in contact with the shaft 102. In other embodiments, however, different applicators may be used. The grease may be a hydrocarbon or silicone based grease and preferably has a suitable viscosity so that it coats and remains on the shaft without running and additionally may have high pressure performance characteristics and be water resistance. In an embodiment, tackiness additives or thickeners may be added to increase the viscosity of the grease. Examples of suitable greases may include Chevron Ultra-Duty Grease EP. As described below, this grease may be used in additional steps of the assembly processed depicted in FIG. 2.

After the grease application station 210, the partly assembled rotor 202 may proceed to a varnish preparation station 220 wherein the rotor is prepared for the application of varnish to the exterior of the rotor core 130. In the illustrated embodiment of the assembly line 200, the varnish preparation station 220 may be used for a mold fitting process in which the partly assembled rotor 202 is placed into one of a plurality of molds 222. To insert and accommodate the partly assembled rotor 202, the molds 222 may include a plurality of interfitting mold parts 224, 226 that can be assembled and disassembled and that together define a cavity 228. The cavity 228 can be sized and shaped to provide a slight clearance at least about the rotor core 130. In the illustrated embodiment, the mold 222 can be configured to support the partly assembled rotor in a vertical, upright position, but in other embodiments, the rotor may be retained in other positions and orientations.

The mold 222 with the partly assembled rotor 202 accommodated therein may proceed to a varnish application station 230 for the application of varnish to the rotor. The varnish functions to electrically insulate the individual windings or laminations of the rotor core, protect the rotor core from contaminants, integrally hold the components of the rotor together, and possibly to dissipate heat that may be generated in the core by the electromagnet interactions. Accordingly, the varnish application station 230 can include a supply of vanish 232 in the form of a nonconductive liquid. The liquid varnish 232 can be introduced to the mold 222 and flows into the clearances between the cavity 228 and around the rotor core 130. In an embodiment, the varnish application station 230 can include an automated varnishing machine 234 having a nozzle 236 for carrying out the introduction of the liquid varnish to the mold 222 through a port or the like. The varnishing machine 234 may be configured to measure particular quantities of varnish and may be adjustable to accommodate molds and rotors of different sizes. In other embodiments, the liquid varnish may be introduced to the mold by hand or may be applied by a different process such as dipping.

Although the intention may be to apply varnish to the rotor core 130 of the partly assembled rotor 202, the application of liquid varnish in a high speed or automated environment may result in overspill of excess varnish or the presence of varnish on unintended portions of the partly assembled rotor. For example, the mold 222 may be not fit properly about the partly assembled rotor 202 or the volume of the cavity 228 may be such that some of the varnish extrudes from the mold and transfers to portions of the shaft 102. In addition, as the mold is transferred about the assembly line, vibrations or rattling may also transfer varnish to the shaft 102. If those portions of the shaft 102 are covered with the grease, the varnish will adhere to the grease rather than the shaft.

After applying the varnish, further processing steps may be performed on the partly assembled rotor 202 at a varnish post-processing station 240. For example, to speed curing or hardening of the liquid varnish into a varnish coating, the mold 222 accommodating the partly assembled rotor 202 may be inserted into an enclosed furnace 242 through an access door 244 or the like and heat can be applied to the combination. The heat generated in the furnace from, for example, heat lamps or other heat sources bakes the liquid varnish as applied to the partly assembled rotor 202 to a harden solid phase or coating on the rotor core 130. The varnish coating will therefore rigidly adhere to the windings, laminations, or other components of the rotor core 130 preventing their separation in use. In accordance with an aspect of the disclosure and unlike the varnish, the formulation of the grease may such that it will maintain its viscous state without melting or hardening. In a possible embodiment, the furnace 242 may be combined with the varnishing machine 234 as the same overall device. In other embodiments, the varnish may be allowed to harden or set naturally without heating or baking. In addition, other procedures that may occur post-application of the varnish include vacuum-pressure impregnation to drive liquid varnish into any voids between the components of the rotor core, painting, chemical treatments, and the like.

After conducting any post-application treatments, the partly complete rotor 202 proceeds to a cleanup station 250 where the mold 222 is disassembled and the rotor removed. At the cleanup station 250, the grease that had been applied to the shaft 102 of the partly assembled rotor 202 at the first grease application station 210 can be removed, for example, by brushing by hand with a wire brush 252 or perhaps even by cloth 254. Because the grease maintained its highly viscous character during the baking process, it can be readily removed without having to apply significant force. In addition, any varnish that adhered to the grease over the shaft 102 will likewise be detached and removed. Accordingly, any suitable application of low impact force may be used to wipe the grease and varnish from the surface of the shaft. The cleanup process therefore cleans the shaft 102 including the portion that will become the exposed shaft length 126. It should be appreciated that mold removal and cleanup can occur at the same or different stations.

In accordance with the disclosure, to facilitate further processing steps for assembling the electric motor, the partly assembled rotor 202 can proceed to a second grease application station 260 for application of additional grease. The grease used at the second grease application station 260 may be of the same type and viscosity of grease contained in the grease supply 212 at the first grease application station 210. To apply the grease, the second grease application station 260 can include a second grease supply 262 and a brush 264, although other application methods are contemplated. In particular, the grease may be brushed or coated onto the shaft 102 of the partly assembled rotor 202 that had just been cleaned at the cleanup station 250. Reapplication of grease to the shaft 102 can facilitate assembly of the bearings onto the partly assembled rotor 202. For example, at bearing assembly station 270, the bearings 140, 142 may be pressed onto the shaft 102 and adjacent to the rotor core 130 using a bearing press tool 272 or the like. Because the bearings 140, 142 and the shaft 102 often form an interference fit, the second reapplication of grease from the second grease application station functions as a lubricant to facilitate the assembly. In those embodiments where the fan plate has been assembled to the rotor core, the first bearing can be set within the central recessed portion of the fan plate. In further embodiments, additional bearing fitting techniques can also be used at the bearing assembly station 270 such as the application of heat or cooling to alter the size of the bearings.

After installing the bearings, the partly assembled rotor can proceed through other processing steps to assemble a completed electric motor. These additional steps may involve inserting the rotor into a stator, completing the appropriate wiring configuration, and placing the rotor and stator into the housing. The results may be a completed new electric motor or a repaired electric motor.

### INDUSTRIAL APPLICABILITY

The present disclosure is applicable to a method of assembling an electric motor, either from raw components to produce a new motor or during the repair of a previously assembled motor. The process begins with a partly assembled rotor 202 for the electric motor having at least a shaft 102 and a rotor core 130 assembled together. Prior to the application of varnish to the rotor core 130, grease is applied to the shaft 102 and possibly to other exposed portions of the partly assembled rotor 202. The grease may be obtained from other operations that must be performed in the assembly of the electric motor; hence, additional materials are not required by the present disclosure. Varnish in a liquid phase is applied to the rotor core 130, for example, by introduction of the liquid varnish into a mold 222 accommodating the partly assembled rotor 202 to provide a varnish coating about the rotor core. Excess varnish may spill onto portions of the shaft 102 and adhere to the grease already applied thereto.

To harden the varnish, the partly assembled rotor 202 and the mold 222 can be baked in a furnace for a requisite time. After baking and removal of the partly assembled rotor 202 from the furnace, the grease is brushed or wiped away from the shaft 102 thereby removing any varnish that had hardened thereon. Application of grease thereby maintains the cleanliness of the shaft 102. The foregoing process has be found to be an improvement over prior methods of removing hardened varnish from the surface of the shaft and other unintended surfaces. These prior methods include the application of high impact forces with a mallet, chisel, or the like to chip away the hardened varnish, which could damage the shaft or rotor core. The present process is also an improvement over attempts to cover or shield the shaft with cardboard or paper, which were found to adhere to the shaft once the varnish had hardened.

After cleanup, the partly assembled rotor 202 can proceed through other processing steps including the installation of a bearing 140 onto the shaft 102. In a further embodiment, the same grease may be reapplied to the shaft to facilitate the bearing installation. In particular, due to the interference fit between the bearing and shaft, the grease functions as a lubricant allowing the bearing to be pressed onto the shaft and slide to the appropriate position. Because the same grease is used at different stages of the assembly process, contamination by or adverse reactions of the grease with other components is avoided.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A method of manufacturing a rotor for an electric motor, the method comprising:
providing a partly assembled rotor including a shaft having an elongated rod-like shape extending between a first end and a second end defining a shaft axis and a rotor core disposed around a portion of the shaft and radially protruding from the shaft, the rotor core having a forward face terminating before the first end to provide an exposed shaft length;
applying grease about at least a portion of the exposed shaft length proximate the forward face of the rotor core;
supporting the partly assembled rotor in a mold;
applying varnish to the rotor core of the partly assembled rotor in the mold and allowing the varnish to harden; and
removing the grease and any deposited varnish thereon from the exposed shaft length.

2. The method of claim 1, further comprising reapplying the grease to at least a portion of the exposed shaft length.

3. The method of claim 2, further comprising pressing a bearing over the exposed shaft length.

4. The method of claim 3, further comprising a step of heating the partly assembled rotor in the mold.

5. The method of claim 4, wherein the step of applying varnish is accomplished by a varnishing machine configured with a nozzle for introduction of the varnish to the mold.

6. The method of claim 5, wherein the step of removing the grease is accomplished by hand with a wire brush.

7. The method of claim 6, wherein the step of applying grease is accomplished with a brush.

8. The method of claim 1, wherein the grease is Chevron Ultra-Duty Grease EP.

9. The method of claim 1, wherein the partly assembled rotor is recovered from a previously constructed electrical motor.

10. The method of claim 1, further comprising the step of assembling a fan plate adjacent to the forward face prior to the step of applying grease, the fan plate including a central recessed portion disposed rearward of a plurality of raised blades extending radially outward from the central recessed portion.

11. An electric motor assembly including a rotor manufactured by the method of claim 1.

12. An assembly line for assembly of electric motors, the assembly line comprising:
a first grease application station having a first supply of grease and adapted for applying the grease to at least a portion of an exposed shaft length protruding from a rotor core of a partly assembled rotor;
a mold fitting station with a plurality of molds each adapted to receive and support the partly assembled rotor;
a varnish application station having a supply of varnish and adapted to apply the varnish the rotor core of the partly assembled rotor in a mold;
an enclosed furnace having at least one access and adapted to receive the partly assembled rotor in the mold, the enclosed furnace generating heat to facilitate hardening of the varnish;
a cleanup station for removing the grease and any of the varnish deposited thereon from the exposed shaft length; and
a second grease application station having a second supply of grease and adapted for reapplying the grease to the exposed shaft length.

13. The assembly line of claim 12, further comprising a mold removal station for removing the partly assembled rotor from the mold.

14. The assembly line of claim 13, wherein the mold removal station and the cleanup station are combined.

15. The assembly line of claim 12, wherein the varnish application station includes a varnishing machine having a nozzle adapted for introduction of varnish to the mold.

16. The assembly line of claim 12, wherein removal of the grease at the cleanup station is performed with a wire brush.

17. The assembly line of claim 12, further comprising a bearing assembly station for installing a bearing onto the exposed shaft length with aid of the grease as reapplied.

18. The assembly line of claim 12, wherein the partly assembled rotor is recovered from a previously constructed electrical motor.

19. The assembly line of claim 12, further comprising an initial assembly portion for assembling the partly assembled rotor including a supply of shafts, the initial assembly portion adapted to assemble the rotor core about the shaft, the rotor core positioned to provide the exposed shaft length protruding from a forward face of the rotor core.

20. A method of repairing a rotor for an electric motor comprising:
recovering a partly assembled rotor from an electric motor that had been previously constructed, the partly assembled rotor including a shaft with an elongated rod-like shape extending between a first end and a second end and a rotor core disposed partially about the shaft and radially extending from the shaft, the rotor core having a forward face terminating behind the first end of the shaft to provide an exposed shaft length protruding from the forward face;
applying grease radially about at least a portion of the exposed shaft length proximate the forward face of the rotor core;
supporting the partly assembled rotor in a mold;
applying varnish to the rotor core of the partly assembled rotor in the mold and allowing the varnish to harden;
removing the grease and any of the varnish deposited thereon from the exposed shaft length with a low impact force;
reapplying the grease radially about at least a portion of the exposed shaft length proximate the forward face of the rotor core; and
installing a bearing on the exposed shaft length with aid of the grease as reapplied.

21. The method of claim 20, further comprising the step of cleaning the partly assembled rotor following the step of recovering.
